(19) United States
(12) Patent Application Publication
(10) Pub. No.: US 2024/0206468 A1
(43) Pub. Date: Jun. 27, 2024

(54) FLUID SOLIDIFYING AND DISINFECTING COMPOSITION AND METHODS OF MAKING AND USING THE SAME

(71) Applicant: Justin Brown, Bristol, TN (US)

(72) Inventor: Justin Brown, Bristol, TN (US)

(21) Appl. No.: 18/391,445

(22) Filed: Dec. 20, 2023

Related U.S. Application Data
(60) Provisional application No. 63/433,790, filed on Dec. 20, 2022.

(51) Int. Cl. A01N 43/64; A01N 25/10; A01N 25/34; C02F 1/50; C02F 1/76

(52) U.S. Cl. CPC A01N 43/64; A01N 25/10; A01N 25/34; C02F 1/50; C02F 1/76; C02F 2303/04

(57) ABSTRACT

The invention is a solidifying tablet and method for disinfecting and solidifying a fluid comprising one or more microorganisms. The disclosed tablet comprises one or more binding agent, solidifying agent, and disinfectant. The tablet can be contacted with a desired liquid (e.g., a liquid comprising bodily fluids and/or a liquid that has medication dissolved therein). Essentially, the disclosed tablet changes the dynamic of the undesired liquid, so that it is decontaminated and in a secure form that is safe to dispose of in the trash.

### CROSS-REFERENCE TO RELATED APPLICATIONS

This patent application claims priority to U.S. Provisional Patent Application No. 63/433,790 filed Dec. 20, 2022, the entire content of which is hereby incorporated by reference.

### TECHNICAL FIELD

The presently disclosed subject matter is generally directed to a composition that effectively solidifies and disinfects a fluid (e.g., a fluid comprising microorganisms and/or other undesirable materials).

### BACKGROUND

The presently disclosed subject matter relates to chemical compounds that are useful in converting liquids to a solid, semi-solid, or gel state. The invention is particularly useful in medical applications for converting one or more liquids to a substantially non-pourable state for ready handling and disposal. The noted liquids are often contaminated with microorganisms, providing a challenge to users for safe disposal. For example, the liquid is often poured down a sink drain or flushed down a toilet. However, these actions can create water toxicity problems which must be addressed by water treatment facilities. Other consumers simply absorb the fluid in a paper towel or other porous material and throw the fluid in a standard garbage receptacle. Unfortunately, these methods can prove dangerous, allowing for cross-contamination and contact with the microorganisms present in the liquid. Current methods of disposing of liquids further includes mixing the undesired fluids with concrete to form a solid mass. However, the cement-formed mass is heavy, can contaminate the mixing vehicles, and exhibits ventilation problems during mixing. Other methods include constructing containers of concrete, steel, or glass to contain such unwanted liquids for an indefinite period. Although the liquids are contained, the method utilizes large volumes of space which is undesirable, especially in a hospital or medical environment. It would therefore be beneficial to provide a composition that can be safely and easily added to a liquid to solidify and disinfect the liquid, allowing for easy disposal.

### SUMMARY

In some embodiments, the presently disclosed subject matter is directed to a disinfecting and solidifying tablet. Specifically, the tablet comprises at least one binding agent, at least one solidifying agent, and at least one disinfectant.

In some embodiments, the tablet further includes one or more additives selected from UV stabilizers and UV absorbers, dyes, antimicrobial agents, lubricants, pigments or other colorants, impact modifiers, antioxidants, stabilizers, surfactants, flow promoters, solid solvents, and combinations thereof.

In some embodiments, the at least one binding agent is selected from cellulose, microcrystalline cellulose, cellulose derivatives, low-substituted hydroxypropyl cellulose (L-HPC), dicalcium phosphate, lactose, sucrose, ethyl cellulose, polydextrose, polyethylene glycol, polyethylene oxide, zeolites, clays, silica gel, aluminum oxide, activated carbon polymethacrylates, polyvinyl alcohols, partially hydrolyzed polyvinyl acetate (PVAc), polysaccharides (e.g., alginic acid, alginates, galactomannans), waxes, fats, fatty acid derivatives, cellulose esters, hydrated chelating agents (e.g., HEDTA, EDTA, MGDA), hydrated carboxylate (e.g., hydrated citrate salts, hydrated tartrate salts), hydrated polycarboxylate, hydrated anionic polymer, hydrated sodium hydroxide, or combinations thereof.

In some embodiments, the solidifying agent is selected from sodium polyacrylate, agar, gelatin, methyl cellulose, xanthan gum, guar gum, carboxyvinyl polymer, hydroxymethyl cellulose, hydroxypropyl cellulose, hydroxyethyl cellulose, acrylic acid-alkyl methacrylate copolymer, casein, zein, polyvinyl alcohol, polyethylene glycol, branched esters, wax, behenyl behenate, behenyl benzoate, alkyl methyl siloxanes, ozokerite, and combinations thereof.

In some embodiments, the disinfectant is selected from dichloro-s-triazinetrione, sodium hypochlorite, calcium hypochlorite, hydrogen peroxide, peracetic acid, benzalkonium chloride, biguanides, bisbiguanides, high molecular weight quaternary ammonium compounds, silver and silver complexes, low molecular weight quaternary ammonium compounds, glutaraldehyde, phenol, isopropyl methylphenol, dequalinium chloride, benzalkonium chloride, benzethonium chloride, alkyldiaminoethylglycine hydrochloride, chlorhexidine hydrochloride, chlorhexidine gluconate, triclosan, 1,8-cineol, ethylene oxide, sodium chlorite, sodium hypochlorite, peroxyacetic acid, ethyl alcohol, octanoic acid, amylphenol, isopropyl alcohol, caprylic acid, or combinations thereof.

In some embodiments, the disinfecting and solidifying tablet comprises about 20-90 weight percent of at least one binding agent, about 1-70 weight percent solidifying agent, and about 1-20 weight percent of at least one disinfectant.

In some embodiments, the disinfecting and solidifying tablet comprises about 60-70 weight percent binding agent, about 30-40 weight percent solidifying agent, and about 1-10 weight percent disinfectant.

In some embodiments, the solidifying agent comprises one or more superabsorbent polymers.

In some embodiments, the disinfecting and solidifying tablet has a pH of about 5-8.

In some embodiments, the at least one binding agent is microcrystalline cellulose, the solidifying agent is sodium polyacrylate, and the disinfectant is dichloro-s-triazinetrione.

In some embodiments, the presently disclosed subject matter is directed to a kit comprising a plurality of disinfecting and solidifying tablets and a plurality of containers configured to house a liquid, wherein the tablet comprises at least one binding agent, at least one solidifying agent, and at least one disinfectant.

In some embodiments, the plurality of containers are of varying size, shape, or both.

In some embodiments, the liquid is selected from water, buffer, bodily fluids, or combinations thereof.

In some embodiments, the presently disclosed subject matter is directed to a method of solidifying and disinfecting a liquid. Particularly, the method comprises contacting the liquid with the disclosed disinfecting and solidifying tablet within a container, wherein after the tablet dissolves within the liquid, tablet solidifies to a solid, semi-solid, or gel and is disinfected.

In some embodiments, the liquid is about 100% disinfected after the tablet has been dissolved.

In some embodiments, the liquid is about 50-99.99% disinfected after the tablet has been dissolved.

In some embodiments, the solidifying is irreversible.

### BRIEF DESCRIPTION OF THE DRAWINGS

FIG. 1a is a top plan view of a solidifying and disinfecting tablet in accordance with some embodiments of the presently disclosed subject matter.

FIG. 1b is a side plan view of a solidifying and disinfecting tablet in accordance with some embodiments of the presently disclosed subject matter.

FIGS. 2a-2l are cross-sectional views of solidifying and disinfecting tablets in accordance with some embodiments of the presently disclosed subject matter.

FIG. 3a is a schematic of a kit in accordance with some embodiments of the presently disclosed subject matter.

FIG. 3b is a perspective view of a container comprising a closure in accordance with some embodiments of the presently disclosed subject matter.

FIGS. 4a-4c illustrate one embodiment of disinfecting and solidifying a liquid in accordance with some embodiments of the presently disclosed subject matter.

FIGS. 5a-5c illustrate one embodiment of disinfecting and solidifying medication in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The presently disclosed subject matter is directed to a solidifying tablet. The term “solidifying” refers to a transition state or process wherein a liquid material becomes solid, semi-solid, or gel form. The term “tablet” broadly refers to tablets of various shapes and sizes, as well as all forms of dispensable or manufactured articles, such as pills, capsules, compressed powders, and the like. For example, a liquid can be contacted with the tablet as disclosed herein, converting the liquid to a solid or gel state, as discussed in detail below. Essentially, the disclosed tablet changes the dynamic of the undesired liquid, so that it is decontaminated and in a secure form that is safe to dispose of in the trash.

The disclosed tablet comprises one or more binding agent, solidifying agent, and disinfectant. The term “binding agent” refers to a composition or compound added to the disclosed tablet that binds the composition together to aid formation of a gel or solid. Stated another way, the binding agent mediates a binding interaction between the tablet and a liquid. Suitable binding agents can include (but are not limited to) cellulose, microcrystalline cellulose, cellulose derivatives, low-substituted hydroxypropyl cellulose (L-HPC), dicalcium phosphate, lactose, sucrose, ethyl cellulose, polydextrose, polyethylene glycol, polyethylene oxide, zeolites, clays, silica gel, aluminum oxide, activated carbon polymethacrylates, polyvinyl alcohols, partially hydrolyzed polyvinyl acetate (PVAc), polysaccharides (e.g., alginic acid, alginates, galactomannans), waxes, fats, fatty acid derivatives, cellulose esters, hydrated chelating agents (e.g., HEDTA, EDTA, MGDA), hydrated carboxylate (e.g., hydrated citrate salts, hydrated tartrate salts), hydrated polycarboxylate, hydrated anionic polymer, hydrated sodium hydroxide, microcrystalline cellulose (e.g., Vivapur® 101), cellulose, magnesium stearate, or combinations thereof.

Thus, in some embodiments, the tablet binding agent can include microcrystalline cellulose. Microcrystalline cellulose is a naturally occurring polymer (also referred to as 2-[4,5-dihydroxy-2-(hydroxymethyl)-6-methoxyoxan-3-yl]oxy-6-(hydroxymethyl)-5-methoxyoxane-3,4-diol) defined by glucose units connected with a 1-4 beta glycosidic bond. Microcrystalline cellulose has the chemical formula (C₆H₁₀O₅)n and the structure set forth below:

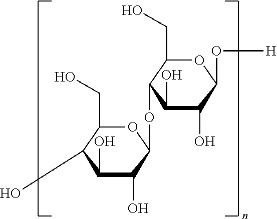

In other embodiments, the binding agent can include magnesium stearate. Magnesium stearate has the chemical formula Mg(C₁₈H₃₅O₂) and includes salt with two equivalents of stearate (the anion of stearic acid) and one magnesium cation (Mg2+).

The binding agent can be produced from any suitable source, such as plant, mineral, animal, fish, fermented plant, or synthetic origination.

The binding agent can be present in the disclosed tablet in an amount of about 60-65 weight percent, based on the total weight of the tablet. Thus, the binding agent can be present in an amount of about 20-90 weight percent (e.g., at least/no more than about 20, 25, 30, 35, 40, 45, 50, 55, 60, 65, 70, 75, 80, 85, or 90 weight percent). It should be appreciated that the disclosed tablet can include embodiments wherein the amount of binding agent is present in an amount outside the range given above.

As set forth above, the disclosed tablet also includes one or more solidifying agents. The term “solidifying agent” refers to any compound or composition added to a liquid that has the effect of facilitating, supporting, and/or effecting the holding together of ingredients in an agglomerated substance. Thus, a suitable solidifying agent can include any agent that thickens, hardens, sets, and/or suspends a liquid. Suitable solidifying agents can include (but are not limited to) sodium polyacrylate, agar, gelatin, methyl cellulose, xanthan gum, guar gum, carboxyvinyl polymer, hydroxymethyl cellulose, hydroxypropyl cellulose, hydroxyethyl cellulose, acrylic acid-alkyl methacrylate copolymer, casein, zein, polyvinyl alcohol, polyethylene glycol, branched esters, wax, behenyl behenate, behenyl benzoate, alkyl methyl siloxanes, ozokerite, and combinations thereof.

Thus, the disclosed tablet can include sodium polyacrylate as a suitable solidifying agent in some embodiments. Sodium polyacrylate is a sodium salt of polyacrylic acid with the chemical formula (CH₂—CH(CO₂Na)—)n. The chemical structure of sodium polyacrylate is given below:

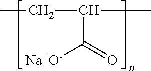

Sodium polyacrylate is an anionic polyelectrolyte that functions as a super-absorbent polymer (SAP). The term “super-absorbent polymer” refers to water-absorbing hydrophilic homopolymers or copolymers that can absorb and retain extremely large amounts of a liquid relative to its own mass. Water-absorbing polymers (classified as hydrogels when mixed) absorb aqueous solutions through hydrogen bonding with water molecules. The ability of a superabsorbent polymer (such as sodium polyacrylate) to absorb water depends on the ionic concentration of the aqueous solution. In deionized and distilled water, a superabsorbent polymer may absorb 400 times its weight (from 30 to 60 times its own volume). There are three main classes of SAPs: cross-linked polyacrylates and polyacrylamides, cellulose- or starch-acrylonitrile graft copolymers, and cross-linked maleic anhydride copolymers. The disclosed solidifying agent can include any type of SAP or combination thereof as defined herein.

The solidifying agent can be present in the tablet in an amount of about 5-70 weight percent solidifying agent based on the total weight of the tablet (e.g., at least/no more than about 5, 10, 15, 20, 25, 30, 35, 40, 45, 50, 55, 60, 65, or 70 weight percent). It should be appreciated that the disclosed tablet can include an amount of solidifying agent in an amount outside the range given herein.

The disclosed tablet further includes one or more disinfectants. The term “disinfectant” refers to any substance or compound that can inactivate, kill, and/or prevent the growth of one or more microorganisms on a surface. The term “microorganism” includes (but is not limited to) bacteria, yeast, fungi, viruses, protists, archaea, and the like. In some embodiments, the disinfectant is capable of killing or inactivating about 100% of the microorganisms in contact with the disinfectant. In other embodiments, about 50-99.99% of the microorganisms are killed or inactivated (e.g., 50, 55, 60, 65, 70, 75, 80, 85, 90, 95, 99, 99.99%).

Suitable disinfectants can include (but are not limited to) dichloro-s-triazinetrione, sodium hypochlorite, calcium hypochlorite, hydrogen peroxide, peracetic acid, benzalkonium chloride, biguanides, bisbiguanides, high molecular weight quaternary ammonium compounds, silver and silver complexes, low molecular weight quaternary ammonium compounds, glutaraldehyde, phenol, isopropyl methylphenol, dequalinium chloride, benzalkonium chloride, benzethonium chloride, alkyldiaminoethylglycine hydrochloride, chlorhexidine hydrochloride, chlorhexidine gluconate, triclosan, 1,8-cineol, ethylene oxide, sodium chlorite, sodium hypochlorite, peroxyacetic acid, ethyl alcohol, octanoic acid, amylphenol, isopropyl alcohol, caprylic acid, or combinations thereof.

Thus, the disclosed tablet can include the disinfectant dichloro-s-triazinetrione in some embodiments. Dichloro-s-triazinetrione (commonly known as dichlor) is a type of stabilized organic chlorine compounds that has been found effective for disinfectant purposes. Specifically, when added to a liquid (e.g., water), dichlor reacts to form free chlorine (e.g., hypochlorite ions) and hydrochloric acid that attack the cell wall of microorganisms. Dichloro-s-triazinetrione has the formula C₃H₄Cl₂N₃NaO₅ and the chemical structure shown below:

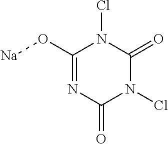

The disinfectant can be present in the disclosed tablet in an amount of about 8 weight percent, based on the total weight of the tablet. Thus, the disinfectant can be present in an amount of from about 0.5-20 weight percent of the tablet (e.g., at least/no more than about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 weight percent). It should be appreciated that the amount of disinfectant can be outside the given range in some embodiments.

In some embodiments, the tablet can be formulated to include about 50 weight percent solidifying agent (e.g., sodium polyacrylate), about 8 weight percent disinfectant (e.g., sodium dichloro-S-triazinetrione), and about 42 weight percent binding agent (e.g., sodium polyacrylate and/or microcrystalline cellulose). One representative, non-limiting example of the tablet is set forth below in Table 1:

TABLE 1
Representative Tablet Formulation

| | | | | Quantity |
|---|---|---|---|---|
| | | | Qty. for 30 | for 100k |
| | % w/w | Mg/Tablet | Tablets (g) | tablets (kg) |
| Sodium Polyacrylate | 50.00 | 500.0 | 15.0 | 50.0 |
| Sodium dichloro-S- | 8.00 | 80.0 | 2.4 | 8.0 |
| triazinetrione | | | | |
| Microcrystalline | 41.50 | 415.0 | 12.5 | 41.5 |
| cellulose | | | | |
| Magnesium stearate | 0.50 | 5.0 | 0.2 | 0.5 |
| Total | 100.0 | 1000.0 | 30.0 | 100.0 |

The tablet can optionally include one or more optional additives in an amount of about 0.001-5 weight percent (e.g., at least/no more than about 0.001, 0.005, 0.01, 0.05, 0.1, 0.5, 1, 1.5, 2, 2.5, 3, 3.5, 4, 4.5, or 5 weight percent. Suitable additives can include (but are not limited to) UV stabilizers and UV absorbers, dyes, antimicrobial agents, lubricants, pigments or other colorants, impact modifiers, antioxidants, stabilizers (e.g., heat stabilizers including organophosphites), surfactants, flow promoters, solid solvents, and other materials added to enhance properties and processability of the tablet. It should be appreciated that the additives are optional, and the tablet can be configured without additive(s).

The disclosed tablet can be formed using any method known in the art. For example, the components of the tablet (e.g., the disinfectant, solidifying agent, binding agent, and optional additives) can be combined into an ordered mixture by high-shear mixing. The mixture can then be compressed to form individual tablets of a suitable dosage size. In some embodiments, the method can further include an encapsulation step whereby a layer of material is positioned on the outer surface of the formed tablet. However, the presently disclosed subject matter is not limited and the tablet can be formed by any known method.

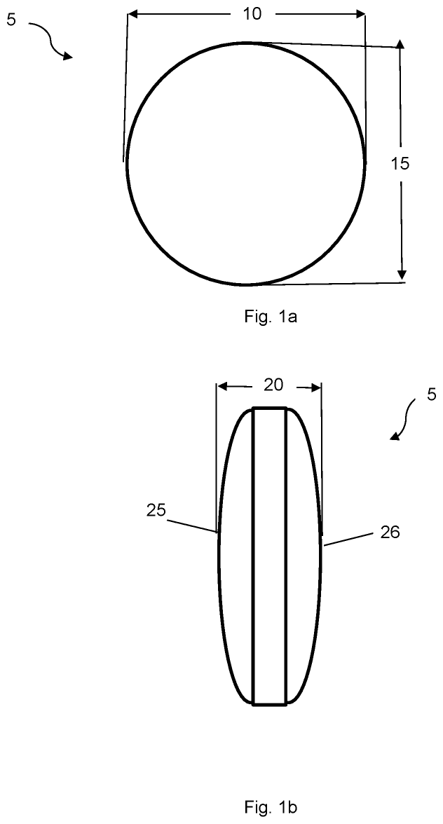

The tablet can be configured in any desired size or shape. As shown in FIG. 1a, tablet 5 can have length 10 and/or width 15 of about 0.01-1.5 inches (e.g., at least/no more than about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, or 1.5 inches). The term “length” refers to the longest horizontal straight-line distance that passes through the center of the tablet. The term “width” refers to the longest vertical distance perpendicular to the length. As shown in FIG. 1b, tablet 5 also includes thickness 20 that can range from about 0.01-1.5 inches (e.g., at least/no more than about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, or 1.5 inches). The term “thickness” refers to the longest straight line distance from front face 25 to opposed rear face 26 of the tablet. It should be appreciated that tablet 5 can be configured any desired dimensions, such that the tablet length, width, and/or thickness can be greater or less than the ranges given above.

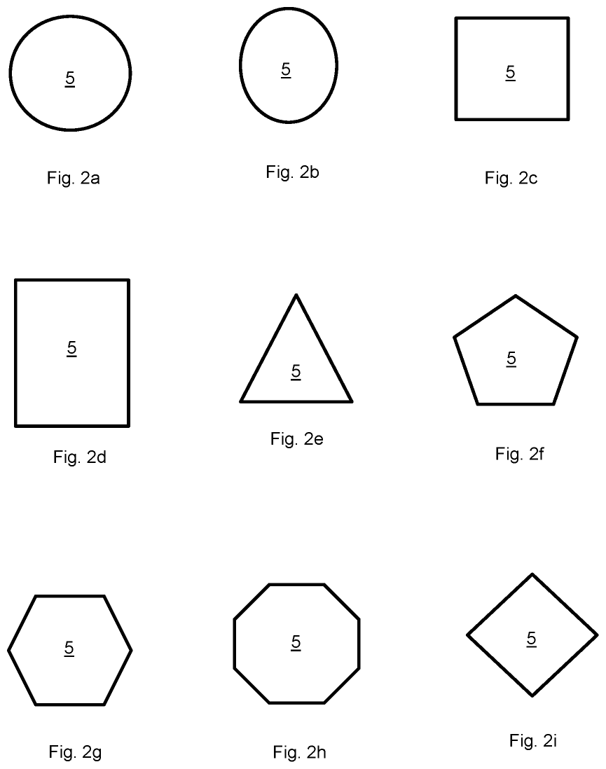

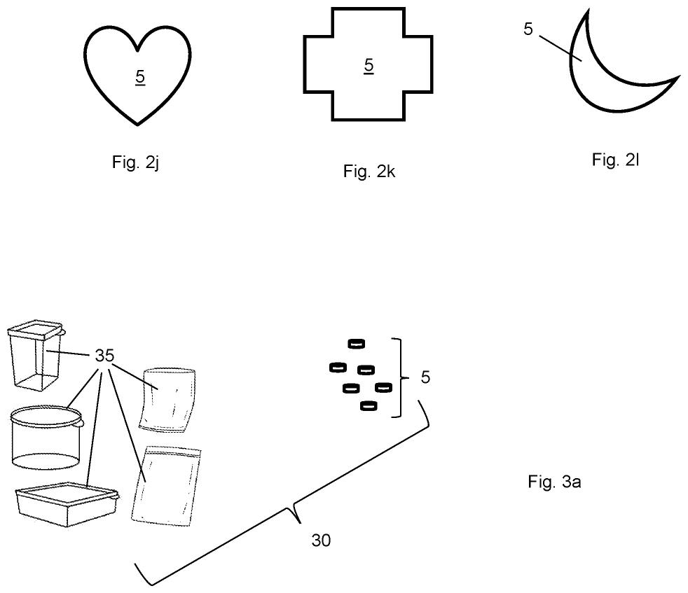

The disclosed tablet can have any desired cross-sectional shape, such as circular, oval, square, rectangular, triangular, pentagonal, hexagonal, octagonal, diamond-shaped, heart-shaped, cross, abstract, and the like, as illustrated in FIGS. 2a-2l. It should therefore be appreciated that the shape of tablet 5 is not limited.

In some embodiments, the disclosed tablet can have a pH of about 5-8 (e.g., at least/no more than about 5, 5.5, 6, 6.5, 7, 7.5, or 8). However, the presently disclosed subject matter is not limited and the pH of the tablet can be outside the given range.

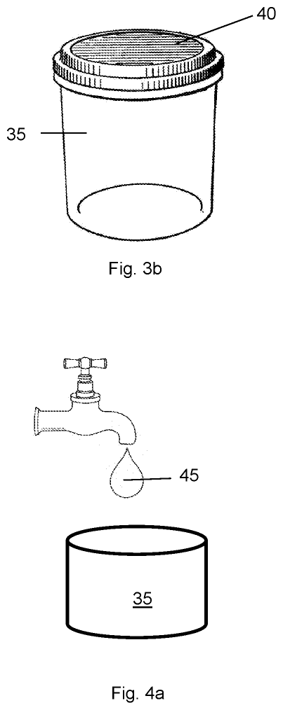

The disclosed tablet can be formed as part of a kit that includes constituents or components that change the dynamics or medium of a fluid. As shown in FIG. 3a, kit 30 can include one or more containers 35. The term “container” broadly refers to any receptacle that can house a liquid and a tablet. For example, container 35 can be configured as a flexible bag or pouch that allows a user to physically knead or mix the components. In other embodiments, the container can be rigid, formed from plastic, glass, ceramics, and the like in the form of a bottle, jar, etc. In some embodiments, the container is puncture-resistant, ensuring that the kit can be safely used without exposure to the fluid housed within the container. The kit can include a plurality of containers that are configured in approximately the same size/shape or can include a plurality of containers configured in a variety of sizes and/or shapes to accommodate different uses.

In some embodiments, the container is sealable. As shown in FIG. 3b, the container can include a lid or other removable closure 40 to maintain a closed, sealed environment.

Container 35 can be configured in any desired size to accommodate a volume of liquid. For example, the container can house about 0.25 cups to 2 cups or more of liquid.

Kit 30 can further include a plurality of tablets 5. In some embodiments, the tablets are of a single size, such that multiple tablets can be used with larger containers. In other embodiments, the tablets can be of varying sizes to accommodate different applications.

The kit can optionally include instructions for use, giving users and indication of how many tablets to use per amount of liquid.

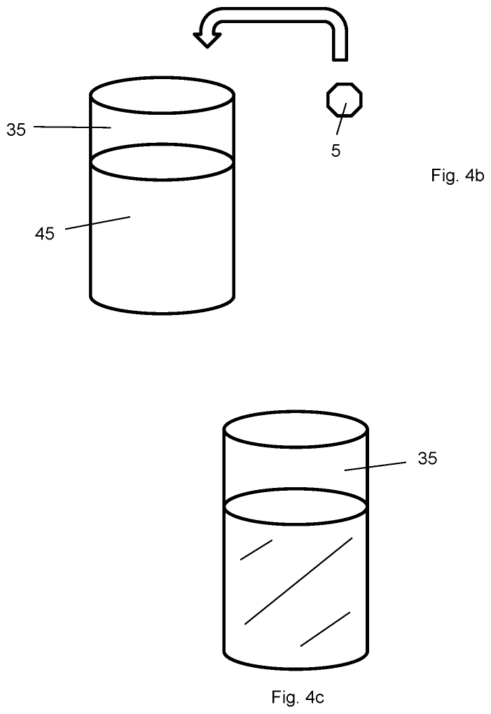

In use, the presently disclosed subject matter includes a method of dispensing a predetermined amount of liquid 45 into an interior cavity of container 35, as shown in FIG. 4a. Liquid 45 can comprise water, saline, buffer, or any desired material. The liquid can be contaminated with one or more microorganisms prior to being deposited into the container or can become contaminated after being deposited into the container. As noted above, the container can be sealable in some embodiments. Accordingly, the container can be pre-sealed to include a predetermined volume of liquid 45. The container and/or liquid can then be used for a desired purpose. The liquid can further include one or more solids dispersed therein (e.g., tissue, skin cells, and the like). In some embodiments, the fluid includes one or more microbial contaminants. When a user wishes to dispose of liquid 45 within the container, one dose of tablet 5 is deposited within the container, as shown in FIG. 4b.

After the tablet is deposited into the container, liquid 45 dissolves the tablet, freeing the solidifying agent and the disinfectant. Once the disinfectant is dispersed within the liquid, it functions to disinfect the liquid, killing or inactivating the microorganisms housed in the liquid. For example, high levels of chlorine can be liberated from the disinfectant into the liquid which not only serves as a disinfectant but also oxidizes any compound dissolved within the liquid.

The solidifying agent also functions to transform the liquid within the container to a solid, semi-solid, or gel state, as shown in FIG. 4c. The term “solid” refers to any type of crystalline material in the form of crystals, powders, or particles. The term “semi-solid” refers to a state in which a material can support its own weight and keep its shape, yet also may be capable of complying in shape when pressure is exhibited. The term “gel” refers to a collection of solid polymer networks dispersed in a liquid that produces a material having properties ranging from a viscous liquid to a loose solid. The solidifying agent therefore absorbs the liquid and any materials dissolved or floating in the liquid and converts the entire mixture into a solid, semi-solid, or gel mass. To activate or encourage the progression disinfection and/or solidification as described above, the user can optionally knead or shake container 35 until a solid or semi-solid mass is created. The user can then safely dispose of container 35 in the trash.

The disclosed tablet, kit, and method can be useful in a variety of applications. For example, when applying a tattoo that has more than one color, a rinse container is used to rinse the needle between color applications. Once the needle is rinsed in the container, the liquid in the container is considered biohazardous waste as it is mixed with bodily fluids. In the disclosed method, tablet 5 can added to the container's contents after the tattoo is finished and the liquid is no longer needed. The tablet quickly dissolves within about 1 minute (e.g., about 10, 20, 30, 40, 50, or 60 seconds), solidifying and disinfecting the liquid. Specifically, the solidifying agent acts to solidify the liquid, while the disinfectant renders the cup contents safe to place in a regular trash can without fear of contamination.

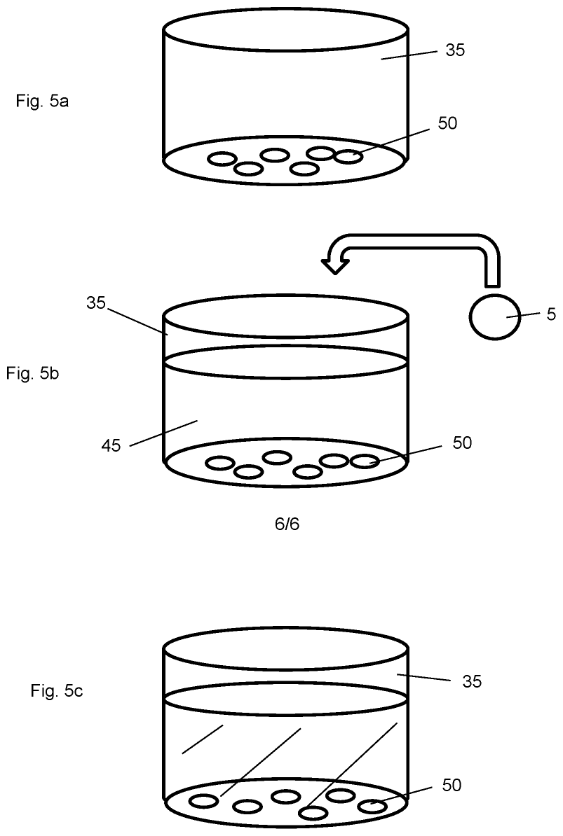

The presently disclosed subject matter can also be used to safely dispose of expired or extra medication. In these embodiments, the user introduces medication 50 into container 35 as shown in FIG. 5a. Liquid 45 can then be added to the interior of the container. Alternatively, the liquid can be added first, followed by addition of the medication. Tablet 5 can then be added to the interior compartment of the container as shown in FIG. 5b. The table will dissolve in the liquid, thereby solidifying and disinfecting the liquid, as shown in FIG. 5c. The medication is also solidified in the mass, preventing access by users (e.g., children) and allowing for safe disposal in a garbage can.

The target medication is not limited and may be liquids or solids, where solid pharmaceutical compositions may be pills (i.e., tablets), capsules, topical compositions, such as patches or tapes, among other forms. The medication can further include any type of active agent, including those that may be subject to abuse (e.g., opioids and other painkillers, hormones, etc.) in a manner that prevents abuse and is environmentally sound (e.g., in that it prevents the active agent from entering the ecosystem).

In other embodiments, the disclosed tablet and method can be used to safely disinfect and dispose of undesirable liquids, such as (but not limited to) urine, blood, and other bodily fluids. In these embodiments, the undesired fluid can be deposited into the interior of container 35. One or more tablets 5 can then be added to the container to solidify and disinfect the fluid. The solidified contents of the container can then be safely disposed into a trash receptacle. Because the solidified contents have been disinfected by tablet 5, there is no or minimal threat of contamination from the liquid.

The disclosed tablet can also be used to quicky and effectively address liquid spills. For example, when a fluid has spilled onto a surface, one or more tablets can be contacted with the spilled liquid. With many liquid wastes, employee safety and/or environmental concerns dictate quick action to minimize the distribution of a spilled flowable waste, hence the need for rapid solidification of the liquid. The tablet dissolves in the liquid, thereby disinfecting and solidifying the liquid. As a result, cleanup is easier, quicker, and safer. In certain medical situations, time is of the essence and avoidance of inadvertent spillage of liquid waste is most important, hence another example where rapid solidification of such liquid waste is important, or even critical.

The presently disclosed subject matter offers many benefits to the user. For example, the tablet allows a user to dispose of a liquid quickly and safely, transforming the liquid into a solid, semi-solid, or gel. The resultant material is also disinfected, allowing it to be safely disposed of without fear of contamination.

Tablet 5 is easy to use, allowing even children or elderly to effective use the tablet to convert a liquid to solid form.

The disclosed tablet includes constituents or components that create an irreversible medium for safe disposal of a contaminated liquid.

Kit 30 may be readily available to users, since it can be purchased in advance and stored in the home of the user, and then used when it is convenient. Such availability and convenience desirably increases the likelihood of proper disposal of pharmaceutical drugs and other liquids.

The disclosed system and method reduces the risks associated with contaminated liquids and pharmaceuticals ending up in fresh water drinking systems.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

What is claimed is:

1. A disinfecting and solidifying tablet, the tablet comprising:
at least one binding agent;
at least one solidifying agent; and
at least one disinfectant.

2. The disinfecting and solidifying tablet of claim 1, further comprising one or more additives selected from UV stabilizers and UV absorbers, dyes, antimicrobial agents, lubricants, pigments or other colorants, impact modifiers, antioxidants, stabilizers, surfactants, flow promoters, solid solvents, and combinations thereof.

3. The disinfecting and solidifying tablet of claim 1, wherein the at least one binding agent is selected from cellulose, microcrystalline cellulose, cellulose derivatives, low-substituted hydroxypropyl cellulose (L-HPC), dicalcium phosphate, lactose, sucrose, ethyl cellulose, polydextrose, polyethylene glycol, polyethylene oxide, zeolites, clays, silica gel, aluminum oxide, activated carbon polymethacrylates, polyvinyl alcohols, partially hydrolyzed polyvinyl acetate (PVAc), polysaccharides (e.g., alginic acid, alginates, galactomannans), waxes, fats, fatty acid derivatives, cellulose esters, hydrated chelating agents (e.g., HEDTA, EDTA, MGDA), hydrated carboxylate (e.g., hydrated citrate salts, hydrated tartrate salts), hydrated polycarboxylate, hydrated anionic polymer, hydrated sodium hydroxide, or combinations thereof.

4. The disinfecting and solidifying tablet of claim 1, wherein the solidifying agent is selected from sodium polyacrylate, agar, gelatin, methyl cellulose, xanthan gum, guar gum, carboxyvinyl polymer, hydroxymethyl cellulose, hydroxypropyl cellulose, hydroxyethyl cellulose, acrylic acid-alkyl methacrylate copolymer, casein, zein, polyvinyl alcohol, polyethylene glycol, branched esters, wax, behenyl behenate, behenyl benzoate, alkyl methyl siloxanes, ozokerite, and combinations thereof.

5. The disinfecting and solidifying tablet of claim 1, wherein the disinfectant is selected from dichloro-s-triazinetrione, sodium hypochlorite, calcium hypochlorite, hydrogen peroxide, peracetic acid, benzalkonium chloride, biguanides, bisbiguanides, high molecular weight quaternary ammonium compounds, silver and silver complexes, low molecular weight quaternary ammonium compounds, glutaraldehyde, phenol, isopropyl methylphenol, dequalinium chloride, benzalkonium chloride, benzethonium chloride, alkyldiaminoethylglycine hydrochloride, chlorhexidine hydrochloride, chlorhexidine gluconate, triclosan, 1,8-cineol, ethylene oxide, sodium chlorite, sodium hypochlorite, peroxyacetic acid, ethyl alcohol, octanoic acid, amylphenol, isopropyl alcohol, caprylic acid, or combinations thereof.

6. The disinfecting and solidifying tablet of claim 1, comprising about 20-90 weight percent of at least one binding agent, about 1-70 weight percent solidifying agent, and about 1-20 weight percent of at least one disinfectant.

7. The disinfecting and solidifying tablet of claim 1, comprising about 60-70 weight percent binding agent, about 30-40 weight percent solidifying agent, and about 1-10 weight percent disinfectant.

8. The disinfecting and solidifying tablet of claim 1, wherein the solidifying agent comprises one or more superabsorbent polymers.

9. The disinfecting and solidifying tablet of claim 1, having a pH of about 5-8.

10. The disinfecting and solidifying tablet of claim 1, wherein the at least one binding agent is microcrystalline cellulose, the solidifying agent is sodium polyacrylate, and the disinfectant is dichloro-s-triazinetrione.

11. A kit comprising: a plurality of disinfecting and solidifying tablets and a plurality of containers configured to house a liquid;
wherein the tablet comprises at least one binding agent, at least one solidifying agent, and at least one disinfectant.

12. The kit of claim 11, comprising wherein the plurality of containers are of varying size, shape, or both.

13. The kit of claim 11, wherein the tablet comprises about 20-90 weight percent of at least one binding agent, about 1-70 weight percent solidifying agent, and about 1-20 weight percent of at least one disinfectant.

14. The kit of claim 11, wherein the liquid is selected from water, buffer, bodily fluids, or combinations thereof.

15. A method of solidifying and disinfecting a liquid, the method comprising: contacting the liquid with the tablet of claim 1 within a container,
wherein after the tablet dissolves within the liquid, tablet solidifies to a solid, semi-solid, or gel and is disinfected.

16. The method of claim 15, wherein the liquid is about 100% disinfected after the tablet has been dissolved.

17. The method of claim 15, wherein the liquid is about 50-99.99% disinfected after the tablet has been dissolved.

18. The method of claim 15, wherein the solidifying is irreversible.

19. The method of claim 15, wherein the tablet comprises about 20-90 weight percent of at least one binding agent, about 1-70 weight percent solidifying agent, and about 1-20 weight percent of at least one disinfectant.

20. The method of claim 15, wherein the at least one binding agent is microcrystalline cellulose, the solidifying agent is sodium polyacrylate, and the disinfectant is dichloro-s-triazinetrione.
